(19) United States
(12) Patent Application Publication
(10) Pub. No.: US 2024/0186060 A1
(43) Pub. Date: Jun. 6, 2024

(54) INDUCTOR

(71) Applicant: LITE-ON Technology Corporation, Taipei City (TW)

(72) Inventors: Chen CHEN, Taipei City (TW); De-Jia LU, Taipei City (TW); Yong-Long SYU, Taipei City (TW); Kai-De CHEN, Taipei City (TW); Chao-Lin CHUNG, Taipei City (TW)

(73) Assignee: LITE-ON Technology Corporation, Taipei City (TW)

(21) Appl. No.: 18/330,386

(22) Filed: Jun. 7, 2023

(30) Foreign Application Priority Data
Dec. 6, 2022 (CN) 202211555083.1

(51) Int. Cl. H01F 27/30; H01F 27/24

(52) U.S. Cl. CPC H01F 27/306; H01F 27/24

(57) ABSTRACT

Disclosed is an inductor, including a magnetic core, a first inner coil and a first outer coil. The magnetic core includes a first base, a magnetic cover, a first center pillar and a first side wall. The first center pillar and the first side wall extend from the first base towards the magnetic cover. The first inner coil surrounds the first center pillar. The first outer coil surrounds the first center pillar. The first inner coil is wound between the first outer coil and the first center pillar. In the inductor, both the first inner coil and the first outer coil are wound around the first center pillar, thereby reducing the overall height of the magnetic core, which is convenient for users to design and use.

### CROSS REFERENCE TO RELATED PRESENT DISCLOSURE

This application claims the priority benefit of Chinese Patent Application Serial Number 202211555083.1, filed on Dec. 6, 2022, the full disclosure of which is incorporated herein by reference.

### BACKGROUND

### Technical Field

The present disclosure relates to the field of inductors, and in particular, to an inductor.

### Related Art

In the field of power supply design, since most of the applications of the vehicle power supply are for wide output voltage ranges, the LLC resonant converter must have a certain resonant tank design to meet the required output voltage range. Regarding the single-point voltage output of a general server power supply, the ratio of the exciting inductance to the resonant inductance is mostly 8 to 12 times, while in order to meet the demand for the wide output voltage range of the vehicle power supply, the ratio of the exciting inductance to the resonant inductance is mostly 2 to 4 times. Thus, in the case of a fixed excitation inductance, the required value of the resonant inductance increases significantly. However, in order to achieve the required value of the resonant inductance, most LLC resonant converters used in the vehicle power supply adopt several resonant inductors in series, and there is a problem that the volume of the resonant inductors in series is too large to be easily combined with existing products.

### SUMMARY

The embodiments of the present disclosure provide an inductor, which can solve the problem that the volume of the current inductor is too large.

In order to solve the above-mentioned technical problem, the present disclosure is implemented as follows.

The present disclosure provides an inductor, which includes a magnetic core, a first inner coil, and a first outer coil. The magnetic core includes a first base, a magnetic cover, a first center pillar, and a first side wall. The first center pillar and the first side wall extend from the first base towards the magnetic cover. The first inner coil surrounds the first center pillar. The first outer coil surrounds the first center pillar. The first inner coil is wound between the first outer coil and the first center pillar.

In one embodiment, the first inner coil and the first outer coil are separated by a first outer distance.

In one embodiment, the first center pillar and the magnetic cover are separated by a first gap.

In one embodiment, the first outer distance is longer than the first gap.

In one embodiment, the first center pillar and the first inner coil are separated by a first inner distance.

In one embodiment, the first inner distance is longer than the first gap.

In one embodiment, there is a first outer coil distance between every two adjacent turns of the first outer coil.

In one embodiment, there is a first inner coil distance between every two adjacent turns of the first inner coil.

In one embodiment, a first outer filler is disposed between the first inner coil and the first outer coil.

In one embodiment, a first inner filler is disposed between the first center pillar and the first inner coil.

In one embodiment, the inductor further includes a second inner coil and a second outer coil. The magnetic core further includes a second base, a second center pillar, and a second side wall. The first base is disposed between the second base and the magnetic cover. The second center pillar and the second side wall extend from the second base towards the first base. The second inner coil surrounds the second center pillar. The second outer coil surrounds the second center pillar. The second inner coil is wound between the second outer coil and the second center pillar.

In one embodiment, the second inner coil and the second outer coil are separated by a second outer distance.

In one embodiment, the second center pillar and the first base are separated by a second gap.

In one embodiment, the second outer distance is longer than the second gap.

In one embodiment, the second center pillar and the second inner coil are separated by a second inner distance.

In one embodiment, the second inner distance is longer than the second gap.

In one embodiment, there is a second outer coil distance between every two adjacent turns of the second outer coil.

In one embodiment, there is a second inner coil distance between every two adjacent turns of the second inner coil.

In one embodiment, a second outer filler is disposed between the second inner coil and the second outer coil.

In one embodiment, the magnetic core further includes a third side wall and a fourth side wall. The third side wall extends from the first base towards the magnetic cover. The first center pillar is disposed between the first side wall and the third side wall. The fourth side wall extends from the second base towards the first base. The second center pillar is disposed between the second side wall and the fourth side wall.

The present disclosure provides an inductor, wherein the first inner coil and the first outer coil are sequentially wound around the first center pillar of the magnetic core to form a total of two layers of coils, thereby reducing the overall height of the magnetic core to facilitate the user's design and use without affecting the power and effect of the inductor.

### BRIEF DESCRIPTION OF THE DRAWINGS

FIG. 1 shows an inductor according to a first embodiment of the present disclosure;

FIG. 2 is a sectional view along the line A-A′ in FIG. 1;

FIG. 3 is a sectional view along the line B-B′ in FIG. 1;

FIG. 4 is another sectional view of the inductor according to the first embodiment of the present disclosure;

FIG. 5 shows an inductor according to a second embodiment of the present disclosure;

FIG. 6 is a sectional view along the line C-C′ in FIG. 5;

FIG. 7 is another sectional view of the inductor according to the second embodiment of the present disclosure;

FIG. 8 is a sectional view of an inductor according to a third embodiment of the present disclosure;

FIG. 9 is another sectional view of the inductor according to the third embodiment of the present disclosure;

FIG. 10 is another sectional view of the inductor according to the third embodiment of the present disclosure;

FIG. 11 is a sectional view of an inductor according to a fourth embodiment of the present disclosure;

FIG. 12 is a sectional view of an inductor according to a fifth embodiment of the present disclosure;

FIG. 13 is a sectional view of an inductor according to a sixth embodiment of the present disclosure; and

FIG. 14 is a sectional view of an inductor according to a seventh embodiment of the present disclosure.

### DETAILED DESCRIPTION OF THE EMBODIMENTS

The embodiments of the present disclosure will be described below in conjunction with the relevant drawings. For clarity, many implementation details are included in the description below. However, it should be understood that these implementation details should not be used to limit the present disclosure. In the following embodiments, the same or similar components are denoted by the same reference numbers.

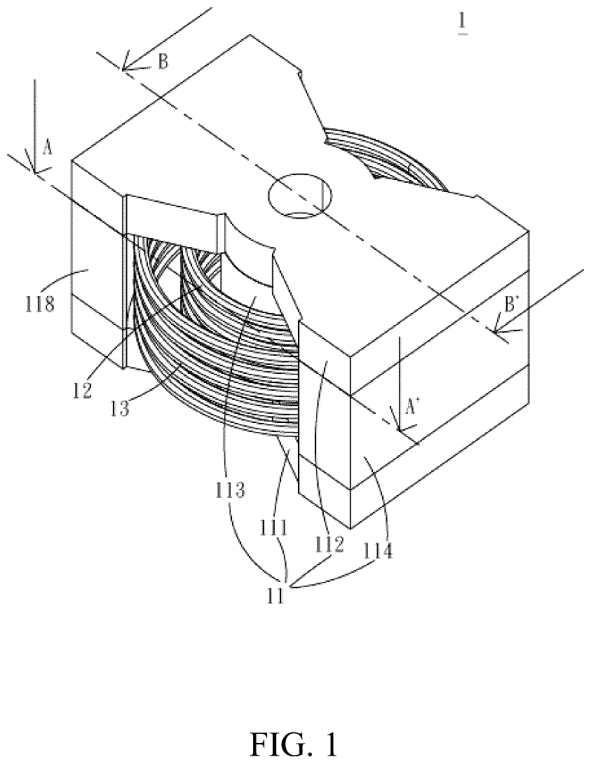

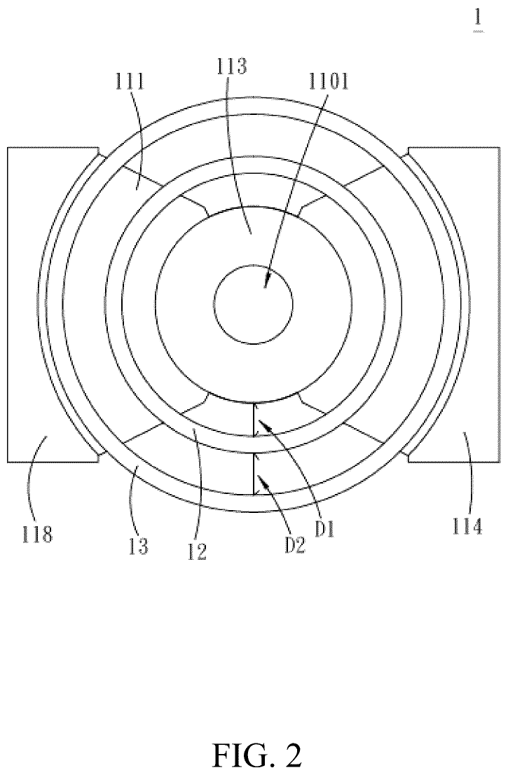

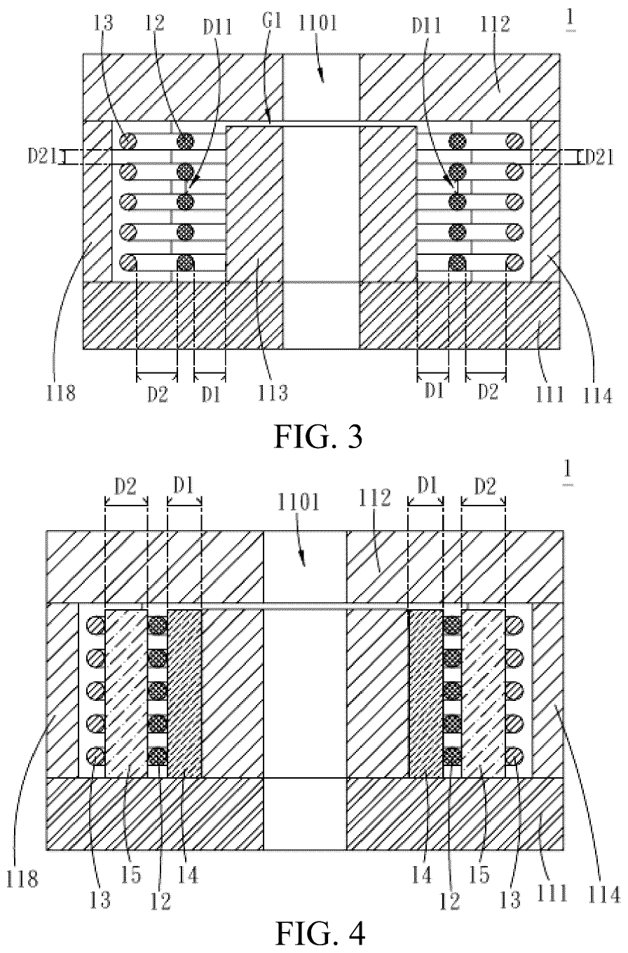

Please refer to FIG. 1 to FIG. 3. FIG. 1 shows an inductor according to a first embodiment of the present disclosure. FIG. 2 is a sectional view along the line A-A′ in FIG. 1. FIG. 3 is a sectional view along the line B-B′ in FIG. 1. As shown in the figures, the present disclosure provides an inductor 1, which comprises a magnetic core 11, a first inner coil 12, and a first outer coil 13. The magnetic core 11 comprises a first base 111, a magnetic cover 112, a first center pillar 113, and a first side wall 114. The first center pillar 113 and the first side wall 114 extend from the first base 111 towards the magnetic cover 112. The first inner coil 12 surrounds the first center pillar 113. The first outer coil 13 surrounds the first center pillar 113. The first inner coil 12 is wound between the first outer coil 13 and the first center pillar 113.

Please also refer to FIG. 4. FIG. 4 is another sectional view of the inductor according to the first embodiment of the present disclosure. As shown in the figure, in this embodiment, the first center pillar 113 is a cylinder, one end of the first center pillar 113 is disposed on the first base 111, the other end of the first center pillar 113 extends toward the magnetic cover 112, and there is a distance from the end surface of the other end of the first center pillar 113 to the surface of the magnetic cover 112 (that is, the first center pillar 113 and the magnetic cover 112 are separated by a first gap G1). The first gap G1 is a spacing between the first center pillar 113 and the magnetic cover 112. In this embodiment, a first inner filler 14 is disposed around the circumference of the first center pillar 113, and then the first inner coil 12 is wound around the first inner filler 14 (that is, a first inner filler 14 is disposed between the first center pillar 113 and the first inner coil 12). In other words, the first center pillar 113 and the first inner coil 12 are separated by a first inner distance D1, and the first inner distance D1 is the thickness of the first inner filler 14. Moreover, the first inner distance D1 is longer than the first gap G1. The first inner distance D1 is longer than the first gap G1, so that the magnetic core loss and the copper wire loss can be reduced. In addition, the first inner coil 12 of this embodiment is fixed on the outer surface of the first inner filler 14 by sparse winding, wherein the winding method of each turn of the first inner coil 12 is that every two adjacent turns need to be separated by a first inner coil distance D11 (that is, there is the first inner coil distance D11 between every two adjacent turns of the first inner coil 12).

A first outer filler 15 is disposed around the circumference of the first inner coil 12 and the first inner filler 14, and then the first outer coil 13 is wound around the first outer filler 15. That is, the first outer filler 15 is disposed between the first inner coil 12 and the first outer coil 13. In other words, the first inner coil 12 and the first outer coil 13 are separated by a first outer distance D2, and the first outer distance D2 is the thickness of the first outer filler 15. Moreover, the first outer distance D2 is longer than the first gap G1. The first outer distance D2 is longer than the first gap G1, so that the magnetic core loss and the copper wire loss can be reduced. In addition, the first outer coil 13 of this embodiment is fixed on the outer surface of the first outer filler 15 by sparse winding, wherein the winding method of each turn of the first outer coil 13 is that every two adjacent turns need to be separated by a first outer coil distance D21 (that is, there is the first outer coil distance D21 between every two adjacent turns of the first outer coil 13).

In addition, in this embodiment, the magnetic core 11 further comprises a third side wall 118. The third side wall 118 extends from the first base 111 towards the magnetic cover 112. The first center pillar 113 is disposed between the first side wall 114 and the third side wall 118. Besides, the magnetic core 11 is further provided with a first through hole 1101, and the first through hole 1101 runs through the first base 111, the first center pillar 113, and the magnetic cover 112 in sequence (that is, the first through hole 1101 runs through the two ends of the magnetic core 11). The first through hole 1101 is helpful for air circulation and heat dissipation.

In this embodiment, the first inner coil 12 and the first outer coil 13 are sequentially wound around the first center pillar 113 of the magnetic core 11 to form a total of two layers of coils, thereby reducing the overall height of the magnetic core 11 to facilitate the user's design and use. In addition, the first inner coil 12 and the first outer coil 13 are further wound by sparse winding, every two adjacent turns of the first inner coil 12 are separated by the first inner coil distance D11, and every two adjacent turns of the first outer coil 13 are separated by the first outer coil distance D21, so that the proximity effect between adjacent turns can be reduced to avoid the problem of excessive magnetic core loss and copper wire loss.

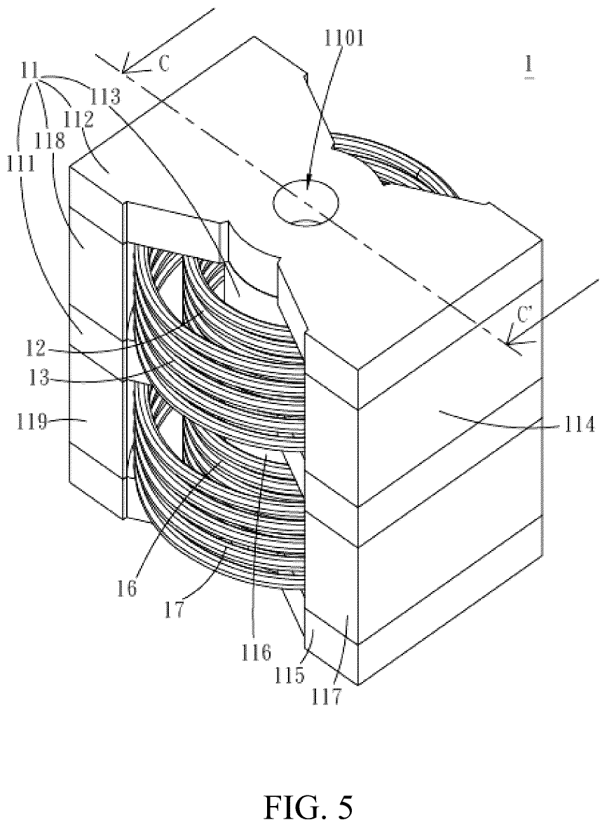

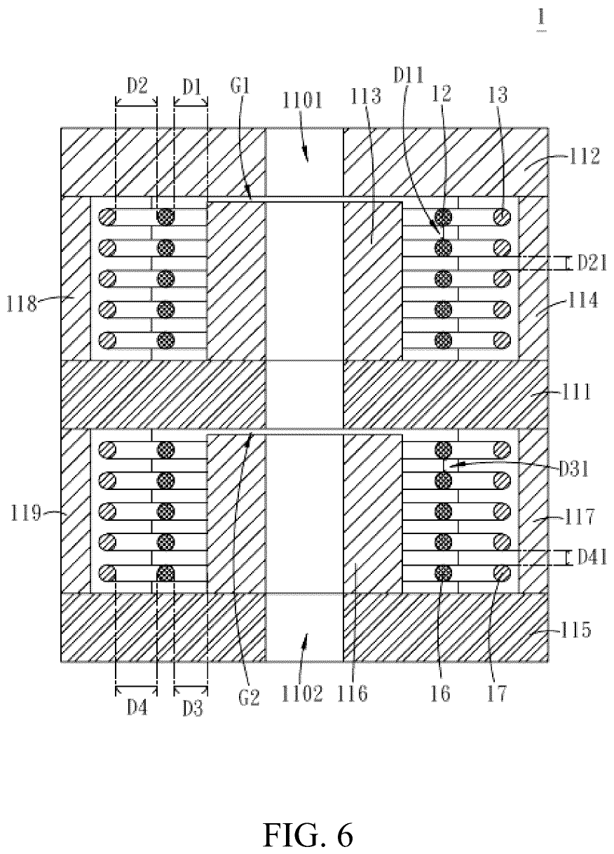

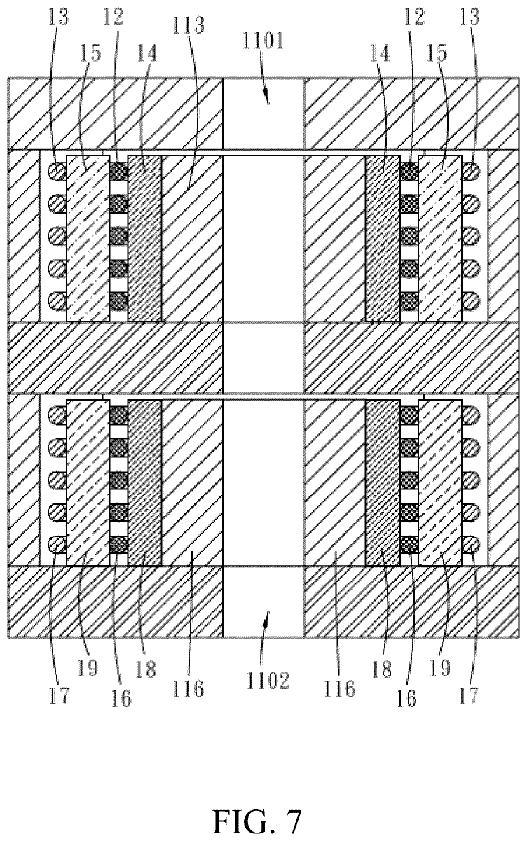

Please also refer to FIG. 5 to FIG. 7. FIG. 5 shows an inductor according to a second embodiment of the present disclosure. FIG. 6 is a sectional view along the line C-C′ in FIG. 5. FIG. 7 is another sectional view of the inductor according to the second embodiment of the present disclosure. As shown in the figures, the difference between this embodiment and the first embodiment lies in the structure of the magnetic core. The inductor 1 of this embodiment further comprises a second inner coil 16 and a second outer coil 17. The magnetic core 11 further comprises a second base 115, a second center pillar 116, and a second side wall 117. The first base 111 is disposed between the second base 115 and the magnetic cover 112. The second center pillar 116 and the second side wall 117 extend from the second base 115 towards the first base 111. The second inner coil 16 surrounds the second center pillar 116. The second outer coil 17 surrounds the second center pillar 116. The second inner coil 16 is wound between the second outer coil 17 and the second center pillar 116.

Part of the structure of the magnetic core of this embodiment is the same as the structure of the magnetic core of the first embodiment. In other words, the structure of the magnetic core of this embodiment is a derivative structure of the structure of the magnetic core of the first embodiment. In this embodiment, the second center pillar 116 and the first base 111 are separated by a second gap G2. The second gap G2 is the spacing between the second center pillar 116 and the first base 111. In this embodiment, the second inner filler 18 is disposed on the peripheral side of the second center pillar 116, the second inner coil 16 is disposed on the outer surface of the second inner filler 18 by sparse winding, and there is a second inner coil distance D31 between every two adjacent turns of the second inner coil 16. The second center pillar 116 and the second inner coil 16 are separated by a second inner distance D3, and the second inner distance D3 is longer than the second gap G2. The second inner distance D3 is longer than the second gap G2, so that the magnetic core loss and the copper wire loss can be reduced. A second outer filler 19 is further disposed on the peripheral side of the second inner coil 16 and the second inner filler 18, the second outer coil 17 is disposed on the outer surface of the second outer filler 19 by sparse winding, and there is a second outer coil distance D41 between every two adjacent turns of the second outer coil 17. The second inner coil 16 and the second outer coil 17 are separated by a second outer distance D4, and the second outer distance D4 is longer than the second gap G2. The second outer distance D4 is longer than the second gap G2, so that the magnetic core loss and the copper wire loss can be reduced.

In addition, in this embodiment, the magnetic core 11 further comprises a fourth side wall 119. The fourth side wall 119 extends from the second base 115 towards the first base 111. The second center pillar 116 is disposed between the second side wall 117 and the fourth side wall 119. Moreover, the magnetic core 11 is further provided with a second through hole 1102, the second through hole 1102 runs through the second base 115 and the second center pillar 116 in sequence. The first through hole 1101 and the second through hole 1102 are mutually connected, thus improving air circulation and heat dissipation. The function of the second through hole 1102 is the same as that of the first through hole 1101.

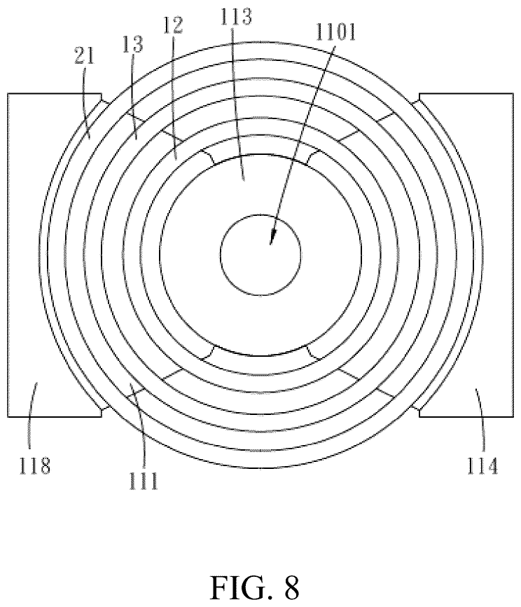

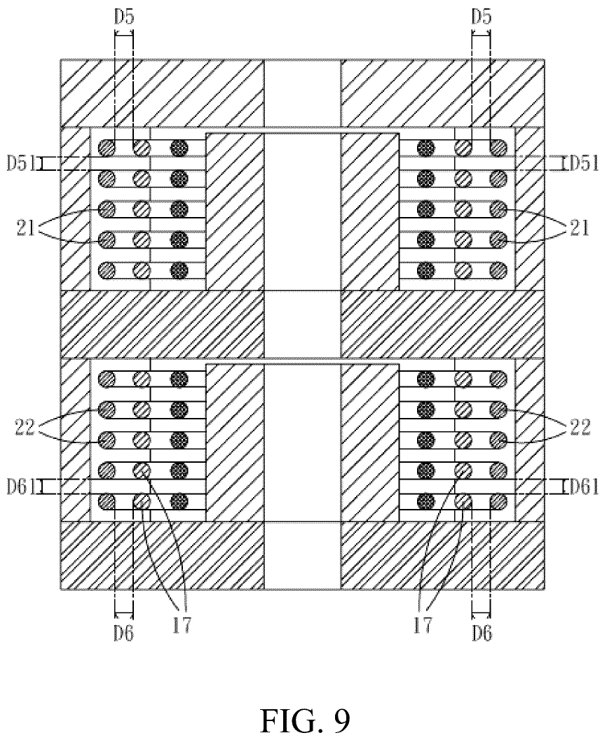

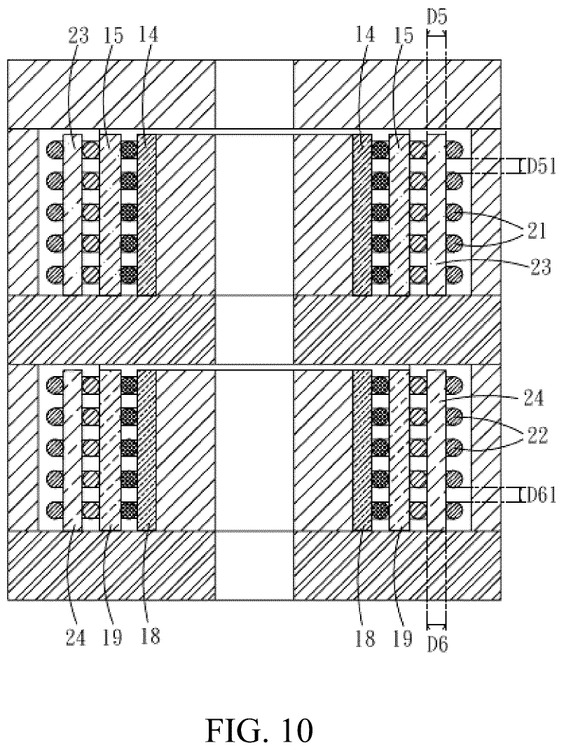

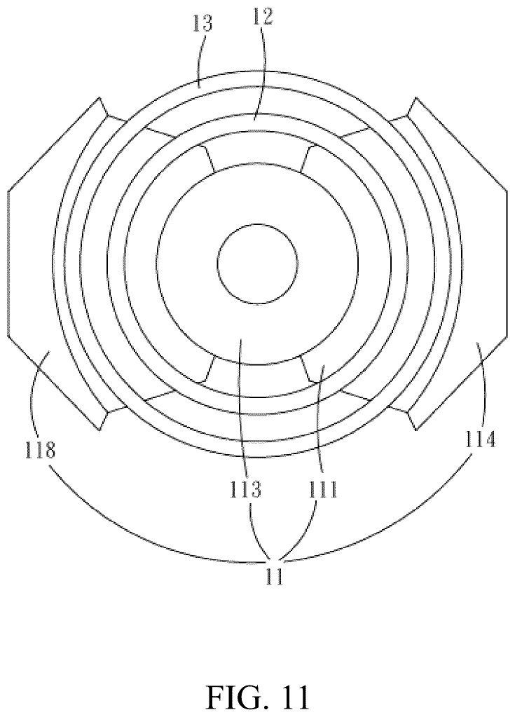

Please refer to FIG. 8 to FIG. 10. FIG. 8 is a sectional view of an inductor according to a third embodiment of the present disclosure. FIG. 9 is another sectional view of the inductor according to the third embodiment of the present disclosure. FIG. 10 is another sectional view of the inductor according to the third embodiment of the present disclosure. As shown in the figures, the difference between this embodiment and the second embodiment is that the inductor further comprises a first auxiliary coil 21 and a second auxiliary coil 22. In this embodiment, a first auxiliary filler 23 is disposed on the peripheral side of the first outer coil 13 and the first outer filler 15, the first auxiliary coil 21 is disposed on the outer surface of the first auxiliary filler 23 by sparse winding, and there is a first auxiliary coil distance D51 between every two adjacent turns of the first auxiliary coil 21. The first auxiliary coil 21 and the first outer coil 13 are separated by a first auxiliary distance D5, and the first auxiliary distance D5 is longer than the first gap G1.

As mentioned above, a second auxiliary filler 24 is further disposed on the peripheral side of the second outer coil 17 and the second outer filler 19, and the second auxiliary coil 22 is disposed on the outer surface of the second auxiliary filler 24 by sparse winding, and there is a second auxiliary coil distance D61 between every two adjacent turns of the second auxiliary coil 22. The second auxiliary coil 22 and the second outer coil 17 are separated by a second auxiliary distance D6, and the second auxiliary distance D6 is longer than the second gap G2.

FIG. 11 is a sectional view of an inductor according to a fourth embodiment of the present disclosure. As shown in FIG. 11, the difference between this embodiment and the first embodiment lies in the structure of the magnetic core 11. In this embodiment, the magnetic core 11 is an RM type magnetic core, and the outer corners of both ends of the first side wall 114 and the third side wall 118 of the magnetic core 11 are reduced inwardly to reduce the volume of the magnetic core 11. The magnetic core 11 of this embodiment can be selected and used according to the needs of users, and then the first inner coil 12 and the first outer coil 13 are sparsely wound in double layers.

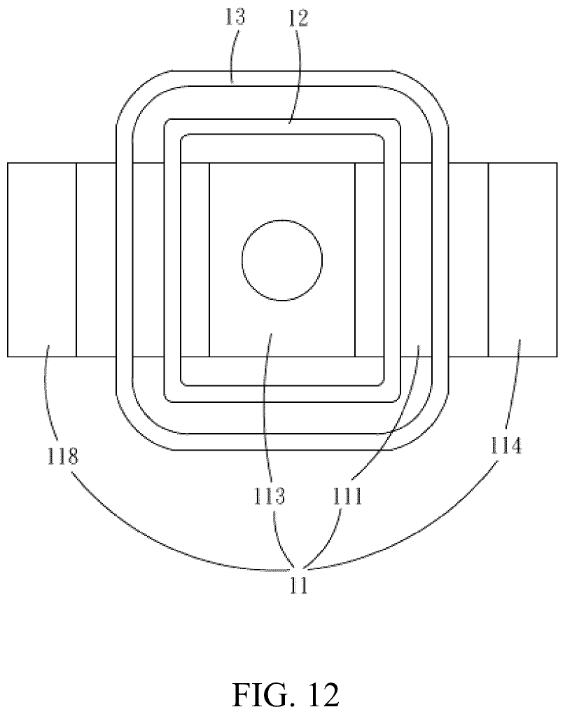

FIG. 12 is a sectional view of an inductor according to a fifth embodiment of the present disclosure. As shown in FIG. 12, the difference between this embodiment and the first embodiment lies in the structure of the magnetic core 11. In this embodiment, the magnetic core 11 is an E-shaped magnetic core, the first center pillar 113 of the magnetic core 11 is a rectangular pillar, the first center pillar 113 is disposed at the center point between the first side wall 114 and the third side wall 118, and the lateral surfaces of the first side wall 114 and the third side wall 118 adjacent to the first center pillar 113 are planes, wherein the width of each of the first side wall 114 and the third side wall 118 is equal to the outer diameter of the first center pillar 113, and the first side wall 114 and the third side wall 118 can cover the first center pillar 113 in a small range. The E-shaped magnetic core in this embodiment has a simple structure and low manufacturing cost. The magnetic core 11 of this embodiment can be selected and used according to the needs of users, and then the first inner coil 12 and the first outer coil 13 are sparsely wound in double layers, and the winding shape of the coils is rectangular.

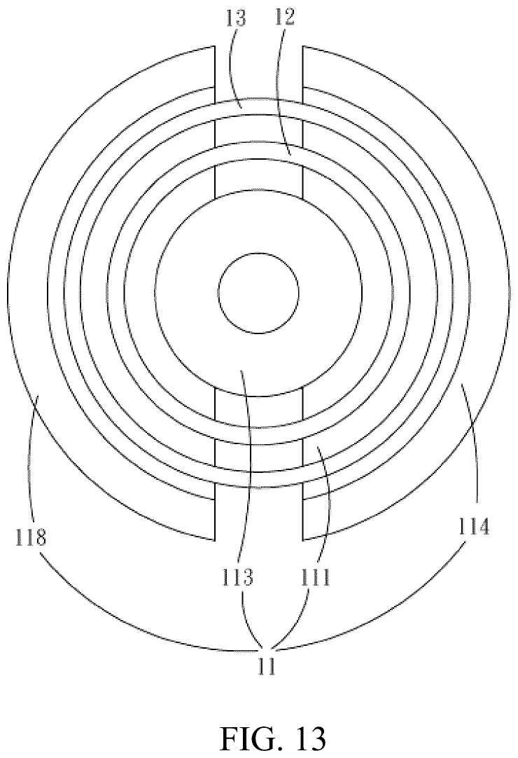

FIG. 13 is a sectional view of an inductor according to a sixth embodiment of the present disclosure. As shown in FIG. 13, the difference between this embodiment and the first embodiment lies in the structure of the magnetic core 11. The magnetic core 11 is a tank-shaped magnetic core. The two ends of the first side wall 114 and the third side wall 118 of the magnetic core 11 extend and cover the first center pillar 113 in a large range. The two ends of the first side wall 114 and the third side wall 118 are not connected to each other, and there are two gaps between the two ends of the first side wall 114 and the two ends of the third side wall 118. In the tank-shaped magnetic core 11 of this embodiment, the first center pillar 113 is covered by the first side wall 114 and the third side wall 118 in a large area, so the shielding effect on the first center pillar 113 is good. The magnetic core 11 of this embodiment can be selected and used according to the needs of users, and then the first inner coil 12 and the first outer coil 13 are sparsely wound in double layers.

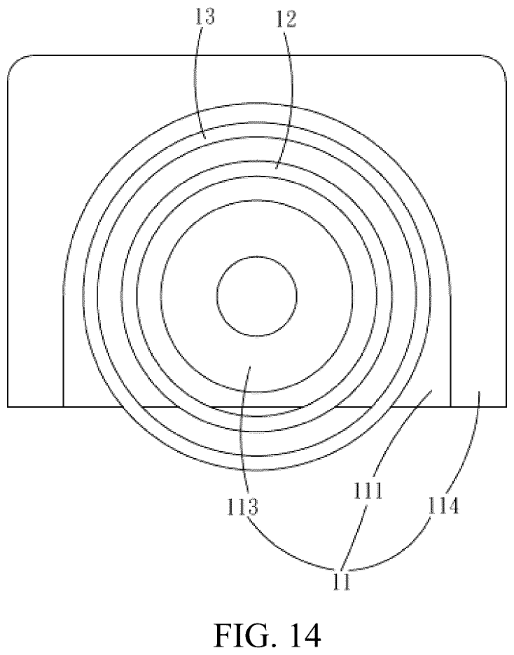

FIG. 14 is a sectional view of an inductor according to a seventh embodiment of the present disclosure. As shown in FIG. 14, the difference between this embodiment and the first embodiment lies in the structure of the magnetic core 11. The magnetic core 11 is an EP type magnetic core. The first side wall 114 of the magnetic core 11 is disposed on one side of the first base 111, and the first side wall 114 covers at least half of the outside of the first center pillar 113. More than half of the volume of the first center pillar 113 of the EP-type magnetic core in this embodiment is covered by the first side wall 114, so the shielding effect on the first center pillar 113 is good. The magnetic core 11 of this embodiment can be selected and used according to the needs of users, and then the first inner coil 12 and the first outer coil 13 are sparsely wound in double layers.

In summary, the present disclosure provides an inductor, wherein the first inner coil and the first outer coil are sequentially wound around the first center pillar of the magnetic core to form a total of two layers of coils, thereby reducing the overall height of the magnetic core to facilitate the user's design and use. Besides, the first inner coil 12 and the first outer coil 13 are sparsely wound, there is the first inner coil distance between every two adjacent turns of the first inner coil, and there is the first outer coil distance between every two adjacent turns of the first outer coil, so that the proximity effect between adjacent turns can be reduced to avoid the problem of excessive magnetic core loss and copper wire loss.

It should further be noted that the term “include,” “comprise,” or any other variation thereof is intended to encompass a non-exclusive inclusion, so that a process, method, commodity, or device that includes a series of elements includes not only those elements but also other elements not explicitly listed, or elements that are inherent to such a process, method, commodity, or device. The element defined by the statement “including one . . . ,” without further limitation, does not preclude the presence of additional identical elements in the process, method, commodity, or device that includes the element.

The foregoing description illustrates and describes several preferred embodiments of the present disclosure. However, it should be understood that the present disclosure is not limited to the form disclosed herein, should not be regarded as an exclusion of other embodiments, but may be used in a variety of other combinations, modifications and environments, and can be modified within the scope of the invention concept described herein, by the above teachings or related fields of technology or knowledge. Modifications and variations made by those skilled in the art without departing from the spirit and scope of the present disclosure should fall within the scope of the present disclosure defined by the appended claims.

What is claimed is:

1. An inductor, comprising:
a magnetic core, comprising:
a first base;
a magnetic cover;
a first center pillar; and
a first side wall;
wherein the first center pillar and the first side wall extend from the first base towards the magnetic cover;
a first inner coil surrounding the first center pillar; and
a first outer coil surrounding the first center pillar;
wherein the first inner coil is wound between the first outer coil and the first center pillar.

2. The inductor according to claim 1, wherein the first inner coil and the first outer coil are separated by a first outer distance.

3. The inductor according to claim 2, wherein the first center pillar and the magnetic cover are separated by a first gap.

4. The inductor according to claim 3, wherein the first outer distance is longer than the first gap.

5. The inductor according to claim 4, wherein the first center pillar and the first inner coil are separated by a first inner distance.

6. The inductor according to claim 5, wherein the first inner distance is longer than the first gap.

7. The inductor according to claim 1, wherein there is a first outer coil distance between every two adjacent turns of the first outer coil.

8. The inductor according to claim 1, wherein there is a first inner coil distance between every two adjacent turns of the first inner coil.

9. The inductor according to claim 1, wherein a first outer filler is disposed between the first inner coil and the first outer coil.

10. The inductor according to claim 1, wherein a first inner filler is disposed between the first center pillar and the first inner coil.

11. The inductor according to claim 1, further comprising:
a second inner coil; and
a second outer coil;
wherein the magnetic core further comprises:
a second base;
a second center pillar; and
a second side wall;
wherein the first base is disposed between the second base and the magnetic cover, the second center pillar and the second side wall extend from the second base towards the first base, the second inner coil surrounds the second center pillar, the second outer coil surrounds the second center pillar, and the second inner coil is wound between the second outer coil and the second center pillar.

12. The inductor according to claim 11, wherein the second inner coil and the second outer coil are separated by a second outer distance.

13. The inductor according to claim 12, wherein the second center pillar and the first base are separated by a second gap.

14. The inductor according to claim 13, wherein the second outer distance is longer than the second gap.

15. The inductor according to claim 14, wherein the second center pillar and the second inner coil are separated by a second inner distance.

16. The inductor according to claim 15, wherein the second inner distance is longer than the second gap.

17. The inductor according to claim 11, wherein there is a second outer coil distance between every two adjacent turns of the second outer coil.

18. The inductor according to claim 11, wherein there is a second inner coil distance between every two adjacent turns of the second inner coil.

19. The inductor according to claim 11, wherein a second outer filler is disposed between the second inner coil and the second outer coil.

20. The inductor according to claim 11, wherein the magnetic core further comprises:
a third side wall; and
a fourth side wall;
wherein the third side wall extends from the first base towards the magnetic cover, the first center pillar is disposed between the first side wall and the third side wall, the fourth side wall extends from the second base towards the first base, and the second center pillar is disposed between the second side wall and the fourth side wall.
